(19) United States
(12) Patent Application Publication
(10) Pub. No.: US 2005/0100310 A1
(43) Pub. Date: May 12, 2005

(54) Setting real time clocks in communications netwroks

(76) Inventor: Andrew James Barker, Nottingham (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/466,880

(22) PCT Filed: Jan. 17, 2002
(86) PCT No.: PCT/GB02/00186

(30) Foreign Application Priority Data
Jan. 17, 2001 (GB) 0101252.5

(51) Int. Cl. H04N 5/781

(52) U.S. Cl. 386/46; 386/125

(57) ABSTRACT

A request requesting a real time clock (RTC) value in a communications network is sent from a network element to a management system via a data communications network. The time taken from the sending of the request to the receipt of the RTC value is compared with a predetermined maximum and, if less than or equal to the maximum, the network element RTC is updated. If above the maximum, the RTC value is discarded, and a fresh request is sent. The received acceptable RTC value may be corrected by subtracting either the minimum transmission time or half the actual transmission time.

This invention relates to communications networks, and in particular to the setting of real time clocks in such networks.

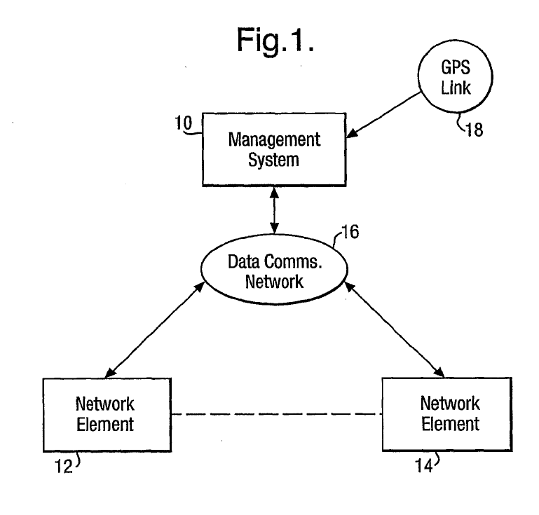

Many networks include a management layer that is used to control and configure elements within the network. An example of such a network is the Synchronous Digital Hierarchy (SDH) transmission network. FIG. 1 shows a typical situation within such a network. A management system 10 and network elements 12, 14 communicate with each other over a data communications network (DCN) 16. The management system carries out a number of functions including configuration, collection of performance metrics and collection of alarm states. In order to enable robust communications, and allow for correct routing of data, standard protocols such as OSI (open systems interconnect) and TCP/IP (transmission control protocol/internet protocol) are used across the network. The network which carries the management layer may be completely independent of the network elements, referred to as out of band, or carried within the traffic that they process, referred to as in band. In the example of SDH, this is typically carried in the data communications channel (DCC) within the traffic section overhead (SOH) as defined in the SDH standards.

Where the management system is collecting performance and alarm state data it is important to know either over what time period the data was collected and/or the precise time a given event occurred. This is particularly important when verifying the quality of service delivered to customers and when fault finding in the network.

In the case of alarms, it is important to correlate accurately alarms to assist in fault finding to establish quickly any traffic loss impact to specific customers.

Management systems typically have a Global Positioning System (GPS) link 18 (FIG. 1) to provide a highly accurate time reference. This enables the time, as a real time clock, to be set within the network elements so that the time that performance data or alarms were collected over can be specified accurately. Once obtained from the GPS, the management system distributes the time over the DCN to all the network elements. Depending on the running accuracy of the real time clock (RTC) within the network element, the management system can update the network element RTC at regular intervals which, typically, vary from hours to days as appropriate.

It is well understood in the art that there are problems associated with setting the real time clock accurately within network elements. These problems arise for three main reasons: transit delays over the data communications network; setting delay when the time is received at a given network element; and data communications network protocol re-transmissions.

The first of these, transit delays, are due to the routing of the messages over the DCN. In a large network, messages may travel over a number of elements each of which stores, processes and forwards the message. The transit delay is typically small, being in the order of 5 ms. As the transit delay is fairly stable and predictable it can be compensated for by simple subtraction.

The setting delay only applies at the receiving network element and is the time taken for the termination of the received message and the setting of the internal RTC. As with the transit delay this is controllable and can be reduced to a few hundred ms by giving the RTC setting a high software priority.

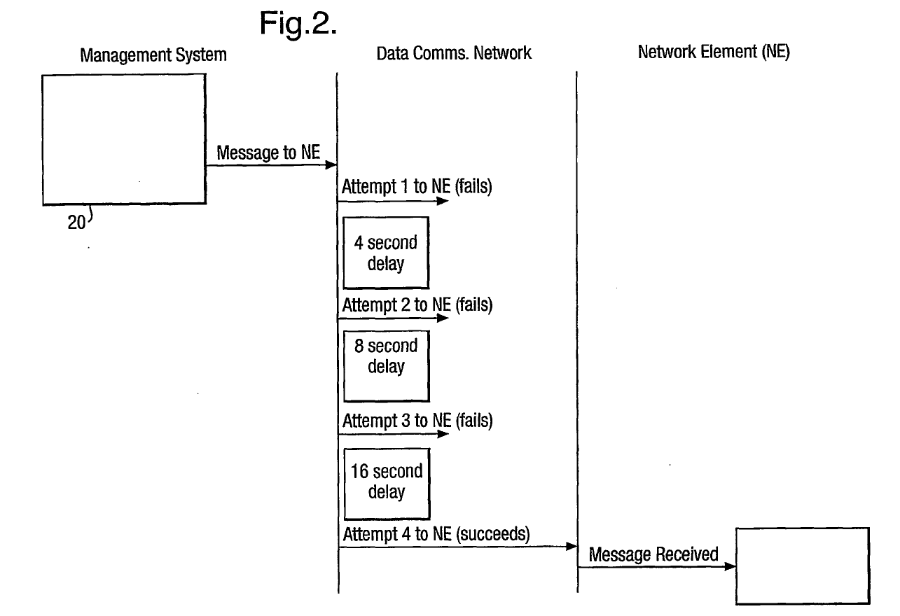

The most problematic source of delay is in DCN protocol re-transmissions. The DCN network is robust and caters for message transmission failures. The protocols used, typically in the transport layer, allow for the detection of failure and the re-transmission of messages. Since failures are likely to be caused by a temporary overload in the DCN network, the retransmission protocols have a back-off mechanism in which there is a waiting time before re-transmission. This may be appreciated from a consideration of FIG. 2 which is a schematic timing diagram showing the sequence of events from the management system, data communications network and network element. A message 20 is sent by the management system to the network element via the DCN. The first three attempts by the DCN to send the message received from the management system on to the network element fail and the message is only sent on the fourth attempt. The delay between successive attempts increases to increase the chances of success. Thus, the delay between the first and second attempts is four seconds; between the second and third attempts is eight seconds; and between the third and fourth attempts is 16 seconds giving rise to a total delay of 28 seconds.

The most significant problem arising from this delay is that neither the management system nor the network element has knowledge of it as re-transmission is handled by protocols within the DCN. Moreover, the message re-transmitted by the DCN protocol is always the same message as supplied by the management system. Thus, in the example given, the time value received at the network element will be 28 seconds slow with respect to real time.

As a result of this delay accumulation, network elements in a large network can vary in time value by a large range. This may be up to 64 seconds depending on the re-transmission times set for the DCN protocols.

Many attempts have been made to solve the above discussed problem. However, none of the solutions proposed are satisfactory. The existing attempts at solving the problem rely on a constant requesting and comparing of times across the network by the management or main control system. Differences are calculated and adjustments made to times sent as required. Such an approach works well on a reasonably controlled network, but reliability is reduced over large networks, where re-transmission may occur often. They are also complex to run on large networks.

Other solutions proposed rely on sending out some form of RTC indication with the traffic carried by the network elements. This propagates over the network quickly allowing for accurate RTC settings. However, such an approach uses up valuable traffic bandwidth and requires a complex interconnection of traffic to ensure that all network elements within a network receive it.

The invention aims, therefore, to provide an improved approach to setting real time clocks which overcomes or ameliorates the disadvantages mentioned above.

In its broadest form, the invention overcomes, at least in part, the above mentioned problems by sending RTC request messages from the network element to the RTC source. This enables the time for the round trip to be monitored. If it is not within a predefined range, the RTC value received is rejected and a fresh request made.

More specifically, there is provided a method of setting a real time clock in a network element of a data communications network having a management system communicating with the network element across the network, the method characterised by: sending a message from the network element to the management system requesting a real time clock (RTC) value; receiving the RTC value at the network element; measuring the time taken between the sending of the RTC request message and receipt of the RTC value; comparing the measured time with a predetermined acceptable time; and if the measured value is acceptable: setting the network element real time clock with the received value.

The invention also provides a network element for a data communications network having a management system communicating with the network element across the network, the network element comprising: a real time clock; a message generator for generating and sending real time clock (RTC) value requests to the management system; a message receiver for receiving requested RTC values from the management system; a timer for measuring the time between sending of an RTC request message and receipt of the RTC value; a comparator for comparing the measured time with a predetermined acceptable time; and means for setting the network element real time clock with the received RTC value if that value is acceptable.

The invention further provides a data communications system comprising: at least one network element and a management system, the network element and the management system communicating across the communications network; characterised in that the system comprising at the network element: a real time clock set by the management system; a message generator for generating and sending real time clock (RTC) value requests to the management system; a message receiver for receiving requested RTC values from the management system; a timer for measuring the time between sending of an RTC request message and receipt of the RTC value; a comparator for comparing the measured time with a predetermined acceptable time; and means for setting the network element real time clock with the received value if that value is acceptable; and at the management system: means for receiving RTC value request messages from the network element and for sending RTC values to the network element in response thereto.

The invention still further provides a method of setting a real time clock in a network element of a data communications network comprising: requesting a real time clock value RTC from a remote RTC source; measuring the period between the RTC request and receipt of an RTC value; and updating the real time clock of the network value if the measured period is within a predetermined acceptable range.

Embodiments of the invention have the advantage that by departing from the prior art arrangement of the management system sending out requests without the knowledge of the network element, the time taken to receive the RTC value can be measured. If it is too high, the RTC value can be discarded.

Preferably, if the number of discarded RTC values exceeds a predetermined number, an alarm is sent to the management system. This has the advantage of alerting the management system to a persistent fault or problem.

Preferably, the acceptable RTC values are modified to take into account the transmission time from the management system. In one preferred embodiment this is achieved by subtracting the minimum transmission time and in another preferred embodiment by subtracting half the measured transmission time. This has the advantage that the real time clock set at the network element is more accurate.

Embodiments of the invention will now be described, by way of example only, and with reference to the accompanying drawings, in which:

FIG. 1, discussed earlier, is a schematic view of a typical network configuration;

FIG. 2, discussed earlier, shows how a message sent from the management system to a network element can accumulate a substantial delay;

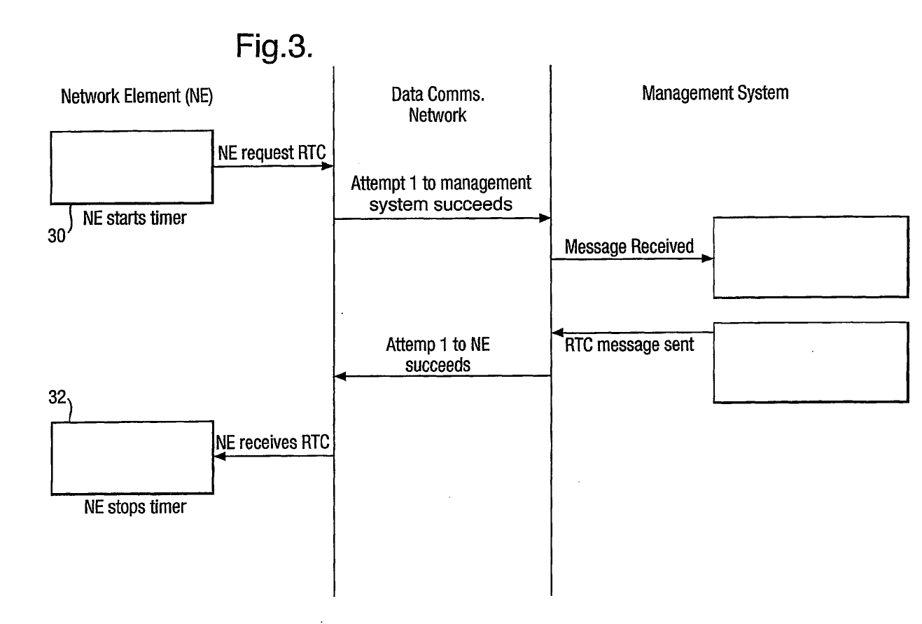

FIG. 3 illustrates the principle of the present invention in terms of message flow between management system and network element;

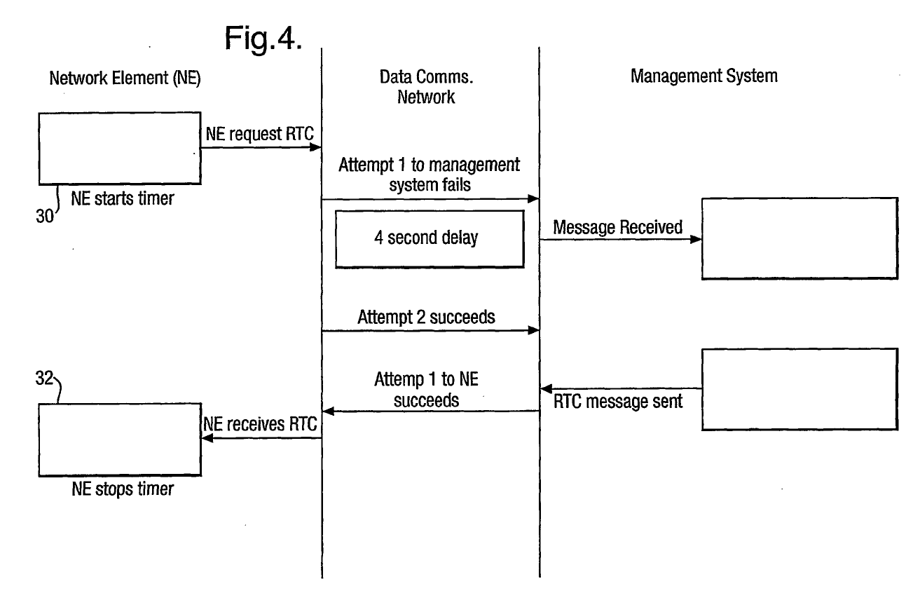

FIG. 4 shows how the FIG. 3 example works with message re-transmission from network element to management system;

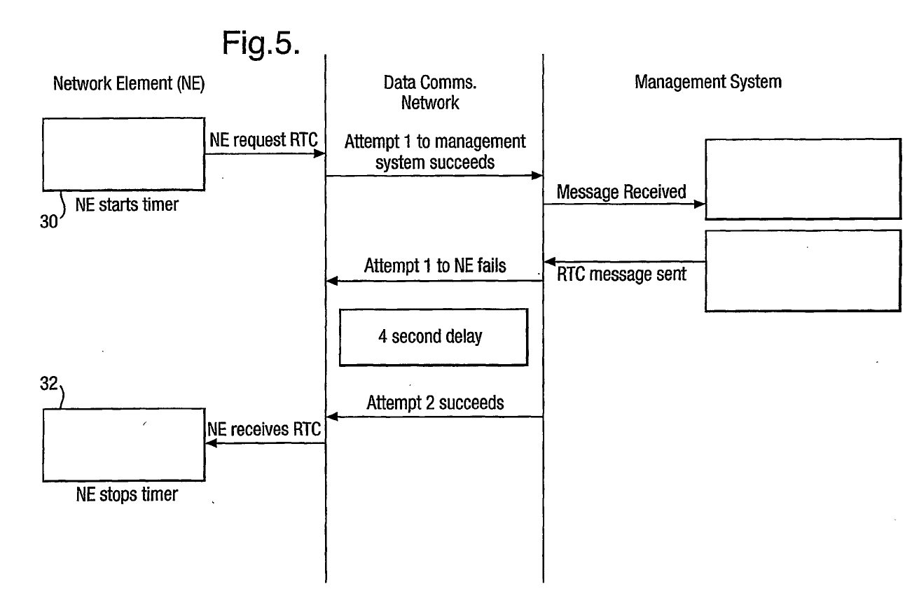

FIG. 5 is a similar view to FIG. 4 but with message re-transmission from management system to network element;

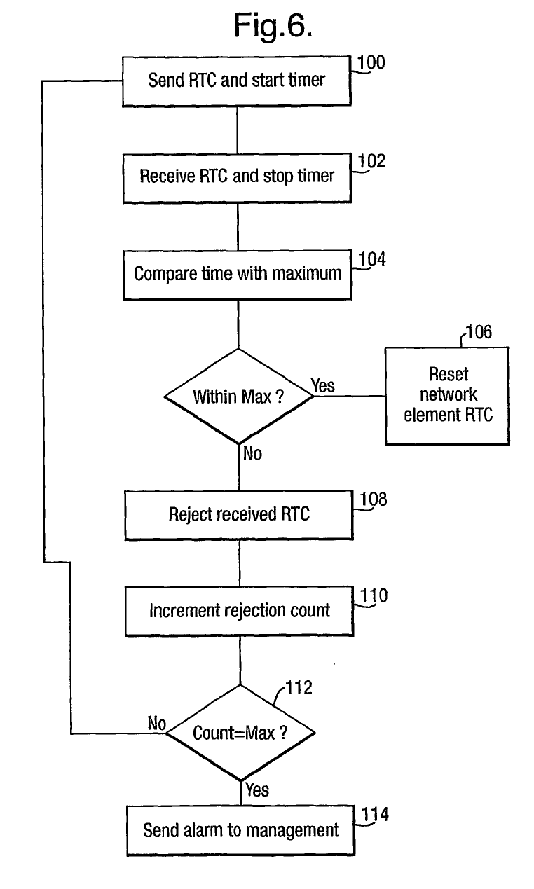

FIG. 6 is a flow chart showing the steps occurring at the network element;

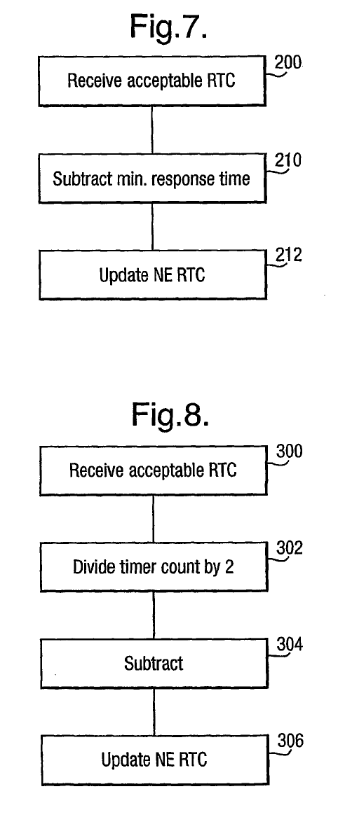

FIG. 7 is a flow chart showing a first method of correcting the received RTC; and

FIG. 8 is a flow chart showing a second method of correcting the received RTC.

The inventors have appreciated that the problems in the prior art systems discussed above arise because the management system and network element have no knowledge of the re-transmission within the DCN network. This is because messages are sent to the network element over the DCN and a reply awaited. This ensures reliable transmission but delays occurring within the DCN are undetectable.

In the embodiment to be described, the process is reversed. Rather than sending RTC settings from the management system at some predetermined time, the RTC is sent in response to a specific request from the network element. The network element can time the period between the issue of the response and the receipt of the RTC and determine the validity of the RTC value by comparing the measured period with the accuracy required within the network element.

The control of the sequence is thus within the network element, which can control and monitor the entire process. As an additional benefit, processing issues related to the extra work involved are distributed across the network rather than handled by one process such as in the management system.

The network element requests the RTC value from the management system and times the period until receipt. This is a relative time and is not related to any inherent accuracy of the current RTC setting, but only the timing of a given period of time. Thus, the validity of the RTC time value can be determined. If the time taken for the response exceeds a maximum acceptable, the network element sends another request after a back off period to allow the DCN to clear.

FIG. 3 shows how this works for a successful request with no re-transmission. It may be assumed, for the purposes of explanation, that the acceptable accuracy of the RTC is to within 5 seconds. That is, the time taken between the network element issuing an RTC request to the management system and the receipt of that RTC by the network element must not exceed 5 seconds.

Each of the propagation legs will have a predictable delay. It may be assumed that the transit time between the network element and the management system is 300 ms in both directions and that the management system has a response time of 500 ms.

Thus, in FIG. 3 at 30 the network element starts a timer and sends an RTC request to the management system across the data communications network. The first attempt to send the message succeeds as does the response from the management system to the network element. The timer is stopped when the RTC is received at the network element at 32. In this case the measured time will be 300 ms+500 ms+300 ms=1.1 seconds. This is within the acceptable accuracy of 5 seconds and so the network element will accept it.

In FIGS. 4 and 5, the sequences are shown where there are re-transmissions. In FIG. 4, the re-transmission is from the network element to the management system. In the example shown the first attempt fails and the second attempt, 4 seconds later, succeeds. The total time for the RTC to reach the management system is (300×2 ms)+400 ms=4600 ms (4.6 seconds). The return path from the management system is successful at the first attempt so that the total time between starting and stopping the timer is 4600 ms+500 ms management response time+300 ms management system to network element propagation time. This gives a total of 5.4 seconds. This time is unacceptable and the network element will therefore reject the RTC value and send a new request.

It will be appreciated that in the FIG. 4 example the RTC received is accurate as there is no delay between the management system and the network element beyond the normal 300 ms delay. However, the network element can only measure the total time for the round trip and cannot determine where the delay has occurred. The network element must therefore reject the received RTC value.

FIG. 5 differs from FIG. 4 only in that the RTC request sent from the network element to the management system is successful at the first attempt but the RTC message sent back to the network element is successful only at the second attempt, inserting a 4 second additional delay. The total time recorded by the network element timer is again 5.4 seconds and the RTC value must be rejected. In this example it will be appreciated that the RTC value actually is inaccurate as the substantial delay has occurred after it was sent by the management system.

Where a received RTC is rejected, the network element continues to use its existing RTC until an RTC request is answered within the acceptable time period.

After the network element has rejected a predetermined number of consecutive RTC values, a time-out will occur and the network element will raise an alarm to the management system to allow intervention by the management system.

FIG. 6 is a flow chart showing the steps in the process at the network element. At step 100 the network element sends out the RTC value to the management system and starts the timer. At step 102 the network element records the RTC value and stops the timer. At step 104 the network element compares the elapsed time. If it is within or equal to the predetermined maximum, the network element resets its RTC at 106. If the elapsed time is greater than the predetermined maximum, the system rejects the RTC value at 108 and the process loops back to the beginning with a fresh RTC request being sent. Following rejection of the RTC, a rejection counter is incremented at 110 and at 112 the value of the counter is compared with a predetermined number. If the counter value is equal to that number an alarm is sent to the management system at 114.

The network element knows the time taken to receive the RTC message from the management system. This knowledge can be used to correct the real time clock.

A first method is to define the minimum response time achievable. In the example given above, this is likely to be about 1 second. The network element then adds 1 second to the received time to compensate for the time taken to receive the message.

A second method bases the correction on the period of time taken for the message to be received. The network element adds half the total time taken to receive the response to reduce any error caused by transmission through the network. If the delay occurs on the return leg, the FIG. 5 example, but the total time is within the acceptable maximum, the error could be increased slightly but still within the acceptable limit.

These two alternatives are illustrated in the flow diagrams of FIGS. 7 and 8 which expand the reset network element step 106 of FIG. 6. In FIG. 7, the acceptable RTC is received at step 200. At 210 the minimum response time is subtracted and at 212 the network element RTC is updated. In FIG. 8 the acceptable RTC is received at 300. At 302 the time counter is halved and at 304 substracted from the received RTC. At 306 the new value is used to update the RTC.

Many variations and modifications to the embodiments described are possible and will occur to those in the art without departing from the scope of the invention which is defined by the claims appended hereto.

1. A method of setting a real time clock in a network element of a data communications network having a management system communicating with the network element across the network, the method characterised by: sending a message from the network element to the management system requesting a real time clock (RTC) value; receiving the RTC value at the network element; measuring the time taken between the sending of the RTC request message and receipt of the RTC value; comparing the measured time with a predetermined acceptable time; and if the measured value is acceptable: setting the network element real time clock with the received value.

2. A method according to claim 1, wherein if the comparison of the measured value and the acceptable value shows the measured value to be unacceptable, the received RTC value is rejected and a further RTC value request message is sent by the network to the management system.

3. A method according to claim 2, wherein upon determination that a received RTC value is unacceptable, the network element compares the number of unacceptable values received with a maximum permissible number and, if the number of unacceptable values received equals the maximum permissible number, sends an alarm to the management system.

4. A method according to any preceding claim, wherein the step of setting the network element real time clock with an acceptable received value comprises correcting the received value to compensate for transmission time.

5. A method according to claim 4, wherein the step of correcting the received RTC value comprises subtracting a minimum transmission time from the received value.

6. A method according to claim 4, wherein the step of correcting the received RTC value comprises subtracting half the measured time taken between sending of the RTC request message and receipt of the RTC value.

7. A network element for a data communications network having a management system communicating with the network element across the network, the network element comprising: a real time clock; a message generator for generating and sending real time clock (RTC) value requests to the management system; a message receiver for receiving requested RTC values from the management system; a timer for measuring the time between sending of an RTC request message and receipt of the RTC value; a comparator for comparing the measured time with a predetermined acceptable time; and means for setting the network element real time clock with the received RTC value if that value is acceptable.

8. A data communications system comprising at least one network element and a management system, the network element and the management system communicating across the communications network; the system comprising at the network element: a real time clock set by the management system; a message generator for generating and sending real time clock (RTC) value requests to the management system; a message receiver for receiving requested RTC values from the management system; a timer for measuring the time between sending of an RTC request message and receipt of the RTC value; a comparator for comparing the measured time with a predetermined acceptable time; and means for setting the network element real time clock with the received value if that value is acceptable; and at the management system: means for receiving RTC value request messages from the network element and for sending RTC values to the network element in response thereto.

9. A network element or data communications system according to claim 7 or claim 8, and further comprising: means for rejecting the received RTC value if the measured time is unacceptable.

10. A network element or data communications system according to claim 9, wherein the network element comprises a further comparator for comparing the number of unacceptable received RTC values with a predetermined maximum, and an alarm generator for generating and sending an alarm to the management system if the predetermined maximum number of unacceptable values has been reached.

11. A network element or data communications system according to any of claims 7 to 10, wherein the network element comprises a real time clock value corrector for correcting received acceptable real time clock values to compensate for transmission time from the management system.

12. A network element or data communications system according to claim 11, wherein the real time clock value corrector comprises a subtractor for subtracting from the acceptable RTC value the minimum time between sending the RTC value request message and receiving the RTC value.

13. A network element or data communications system according to claim 11, wherein the real time clock value corrector comprises a subtractor for subtracting half the measured time taken between sending of the RTC request message and receipt of the RTC value.

14. A method of setting a real time clock in a network element of a data communications network comprising: requesting a real time clock value RTC from a remote RTC source; measuring the period between the RTC request and receipt of an RTC value; and updating the real time clock of the network value if the measured period is within a predetermined acceptable range.
